(19) United States
(12) Patent Application Publication
(10) Pub. No.: US 2026/0130316 A1
(43) Pub. Date: May 14, 2026

(54) SEED METER WITH POSITIVE AND NEGATIVE AIRFLOW THROUGH A SEED DISK

(71) Applicant: Deere & Company, Moline, IL (US)

(72) Inventor: Joseph D. BASSETT, Sycamore, IL (US)

(73) Assignee: Deere & Company, Moline, IL (US)

(21) Appl. No.: 19/443,989

(22) Filed: Jan. 8, 2026

Related U.S. Application Data
(63) Continuation of application No. PCT/US2024/037443, filed on Jul. 10, 2024.
(60) Provisional application No. 63/512,839, filed on Jul. 10, 2023.

(51) Int. Cl. A01C 7/10; A01C 7/04; A01C 7/20

(52) U.S. Cl. CPC A01C 7/105; A01C 7/0443; A01C 7/046; A01C 7/205

(57) ABSTRACT

A seed meter including a seed disk provided in a seed disk housing. The seed disk includes air bearings and holes for receiving seeds. The seed meter further includes a vacuum producing device configured to generate a vacuum pressure in the seed disk housing. The vacuum pressure generates negative airflow through the holes for loading and holding the seeds in a respective hole, and the air bearings are configured to emit positive airflow for repelling seeds from other parts of the seed disk. The seed meter further includes a seed tube portion having an interior surface including a spiral groove that guides seeds along a groove path and into the seed disk housing in a direction opposite that of a rotation of the seed disk.

### CROSS-REFERENCE TO RELATED APPLICATIONS

This application is a Bypass Continuation of International Patent Application No. PCT/US 2024/037443 filed Jul. 10, 2024, which claims the benefit of and priority to U.S. Provisional Ser. No. 63/512,839 filed Jul. 10, 2023, and is related to International Patent Application No. PCT/US 021/065403 filed Dec. 28, 2021, which claims priority to U.S. Provisional Ser. No. 63/132,279 filed Dec. 30, 2020, each of which is hereby incorporated by reference herein in its entirety.

### TECHNICAL FIELD

The present disclosure relates generally to agricultural equipment, and more specifically, to agricultural planters with seed meters having a vacuum producing device for loading seeds and an outlet pressure for directing the seeds to the soil. The present disclosure also relates to agricultural planters with seed meters having a positive air pressure for singulating seeds.

### BACKGROUND Agricultural planters typically have seeders that use positive air pressure to push or load

seeds onto a seed disk. Additionally, the same positive pressure that is used to load the seeds onto the seed disk is then used to dislodge or eject the seeds into a seed outlet for directing the seed to a specific area in the furrow. In seeders where positive air pressure is used to direct seeds to the furrow, the seeds usually travel at a relatively high speed when compared to vacuum seeders. The high speed can cause seeds to bounce after hitting the furrow, thus resulting in non-ideal or non-uniform placement of seed on farmland.

Vacuum seeders usually struggle in creating enough vacuum for loading seeds onto seed disks since vacuum seeders share a same vacuum producing device across multiple seeders. Since vacuum is shared across multiple seeders, the vacuum should be generated over a large distance. Vacuum seeders also rely on gravity when directing seeds to the furrow which can result in imprecise seed placement.

Regardless of the type of pressure that is used to load seeds onto a seed disk (e.g., positive air pressure or vacuum pressure), conventional seeders utilize seed meter designs that include mechanical singulators. Mechanical singulators are mechanical devices that, by virtue of their shape and position, attempt to guide seeds into a respective hole location within a seed disk for loading. However, certain mechanical singulators are poorly designed and, as a result, can damage seeds and can fail to prevent improper seed loading (e.g., multiple seeds in one hole of a seed disk, loading seed(s) into rail openings of a seed disk, skipped or missed holes in seed disk, etc.). In addition, since mechanical singulators are limited insofar as the number of seeds they are able to guide with an acceptable level of accuracy, their use also necessarily limits the angular speed at which a spinning seed disk is able to be loaded and dispense seeds.

Further still, as seeds get funneled into a seed meters of a conventional seeder, the seeds tend to form a pool of seeds within the seed meter. As the seed disk within the seed meter rotates, the motion of the pool of seeds tends to propagate in the same direction as the rotation of the seed disk. This propagation of seeds is caused by friction between the seeds and the seed disk, and as the rotation of the speed disk increases, so too does the propagation of the pool of seeds.

Conventional approaches to addressing the foregoing seed propagation problem include providing one or more mechanisms or materials (e.g., “wear parts”) within the seed meter that attempt to exert a counteracting friction on the seeds, in order to hold or offset the propagation force created by the rotating seed disk. These approaches, however, are ineffective, expensive, and require the continual replacement and/or servicing of such wear mechanisms or materials.

Accordingly, there is a need for a new type of seed meter and planter that addresses the problems associated with conventional vacuum and positive air pressure seeders, avoids limitations of mechanical singulators and resolves the propagation of seeds problems.

The present disclosure is directed to solving these and other problems.

### SUMMARY

Since vacuum seeders typically struggle to create more vacuum for use with large seed disks, embodiments of the present disclosure provide seed meters for use in planters where each seed meter includes a vacuum producing device. By having a vacuum producing device on each seed meter, vacuum is not shared between multiple seed meters, thus there is no need to convey vacuum over a large distance. With such a design, larger seed disks can be used. Embodiments of the present disclosure offer simplicity in design with fewer wear components compared to conventional seeders.

Embodiments of the present disclosure provide a seed meter. The seed meter includes a seed disk provided in a seed disk housing. The seed disk includes a plurality of air bearings and a plurality of holes for receiving seeds. The seed meter further includes a vacuum producing device that is configured to generate a vacuum pressure in the seed disk housing. The vacuum pressure generates negative airflow through the plurality of holes for loading and holding the plurality of seeds in a respective hole, and the plurality of air bearings are configured to emit positive airflow for repelling seeds from other parts of the seed disk.

In some embodiments, the seed meter further includes a seed tube coupled to the seed disk housing. The seed tube is configured to introduce the plurality of seeds into the seed meter and includes a rounded or elliptical-shaped seed tube portion. The seed tube portion has an interior surface comprising a spiral groove that extends from one end of the seed tube portion to another end of the seed tube portion. When positive air presser formed within the seed disk housing drives seeds into the seed tube portion, the positive air pressure forces the seeds against an angled surface of the spiral groove and in response, the spiral groove guides the seeds along a groove path in a direction that is opposite that of a rotation of the seed disk.

### BRIEF DESCRIPTION OF THE DRAWINGS

The foregoing and other advantages of the present disclosure will become apparent upon reading the following detailed description and upon reference to the drawings.

FIG. 1 illustrates a block diagram of a first seed meter, according to some implementations of the present disclosure;

FIG. 2 illustrates a block diagram of a second seed meter, according to some implementations of the present disclosure;

FIG. 3 illustrates a top perspective view of a seed meter, according to some implementations of the present disclosure;

FIG. 4 illustrates a bottom perspective view of the seed meter of FIG. 3;

FIG. 5 illustrates a front plan view of the seed meter of FIG. 3;

FIG. 6 illustrates a right side view of the seed meter of FIG. 3;

FIG. 7 illustrates a back plan view of the seed meter of FIG. 3;

FIG. 8 illustrates a left side view of the seed meter of FIG. 3;

FIG. 9 illustrates a top plan view of the seed meter of FIG. 3;

FIG. 10 illustrates a bottom plan view of the seed meter of FIG. 3;

FIG. 11 illustrates a left perspective view of components of the seed meter of FIG. 3 without housing covers, according to some implementations of the present disclosure;

FIG. 12 illustrates a right perspective view of components of the seed meter of FIG. 3 without housing covers, according to some implementations of the present disclosure;

FIG. 13 illustrates components of the seed meter of FIG. 3, according to some implementations of the present disclosure;

FIG. 14 illustrates components of the seed meter of FIG. 3, according to some implementations of the present disclosure;

FIG. 15 illustrates a cross section of the seed meter of FIG. 3, according to some implementations of the present disclosure;

FIG. 16 illustrates a top perspective view of a seed meter, according to some implementations of the present disclosure;

FIG. 17 illustrates a top perspective view of the seed meter of FIG. 16;

FIG. 18 illustrates airflow through a first portion of the seed meter of FIG. 1, according to some implementations of the present disclosure;

FIG. 19 illustrates airflow through a second portion of the seed meter of FIG. 17, according to some implementations of the present disclosure;

FIG. 20 illustrates a seed being captured on a seed disk of the seed meter of FIG. 17, according to some implementations of the present disclosure;

FIG. 21 illustrates a zoomed in and cross-sectional view of a portion of an alternate embodiment of the seed meter of FIG. 16, according to some implementations of the present disclosure;

FIG. 22 illustrates a seed being captured on a seed disk of the alternate embodiment of the seed meter of FIG. 21, according to some implementations of the present disclosure;

FIG. 23 illustrates a left perspective view of a portion of the seed tube of the alternate embodiment of the seed meter of FIG. 21, according to some implementations of the present disclosure;

FIG. 24 illustrates a cross-sectional view of the portion of the seed tube of FIG. 23, according to some implementations of the present disclosure;

FIG. 25A illustrates several examples of seeds being captured on the seed disk of the seed meter of FIG. 16;

FIG. 25B is a zoomed in portion of FIG. 25A showing single seed capture, according to some implementations of the present disclosure;

FIG. 25C is a zoomed in portion of FIG. 25A showing a first example of an improper seed capture, according to some implementations of the present disclosure;

FIG. 25D is a zoomed in portion of FIG. 25A showing a second example of an improper seed capture, according to some implementations of the present disclosure;

FIG. 25E is a zoomed in portion of FIG. 25A showing a third example of an improper seed capture (a skip), according to some implementations of the present disclosure;

FIG. 26 illustrates a portion of the seed disk of FIG. 16, showing airflow at the edge of the seed disk, according to some implementations of the present disclosure;

FIG. 27 illustrates a portion of the seed disk of FIG. 16, showing airflow at the end of the seed disk, according to some implementations of the present disclosure;

FIG. 28 illustrates a valve system on the seed disk of FIG. 16, according to some implementations of the present disclosure.

While the present disclosure is susceptible to various modifications and alternative forms, specific implementations have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

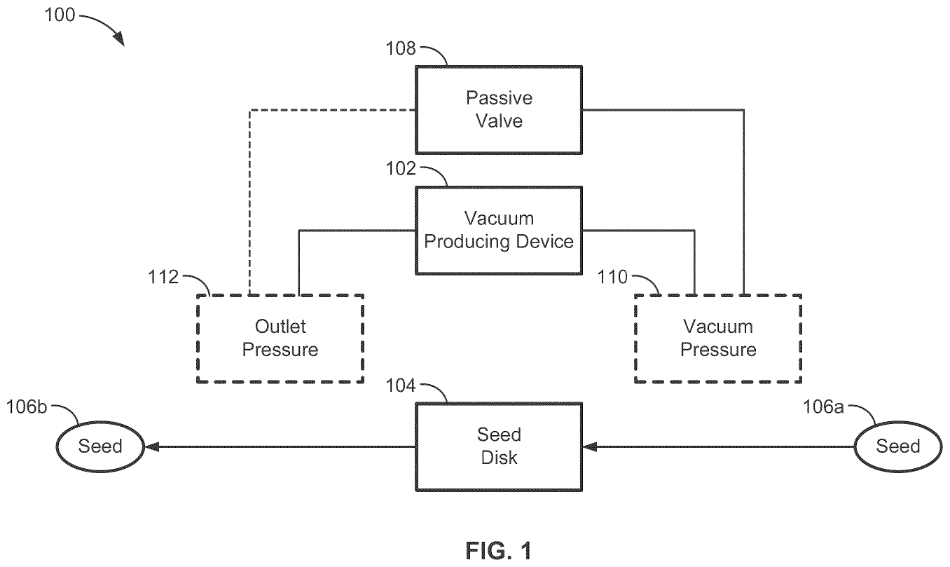

FIG. 1 illustrates a block diagram of a first seed meter 100, according to some implementations of the present disclosure. The seed meter 100 includes a vacuum producing device 102, a seed disk 104, and a passive valve 108. The seed meter 100 receives a seed at an input side and expels the seed from an output side. In FIG. 1, seed 106a represents the received seed at the input side, and seed 106b represents the expelled seed from the output side. The vacuum producing device 102 generates a vacuum pressure 110 at the input side of the seed meter 100. The vacuum pressure 110 facilitates loading the seed on the seed disk 104.

The vacuum producing device 102 can include an impeller and a servo or motor for controlling the rotational speed of the impeller. The seed disk 104 includes a flat surface with holes such that the vacuum pressure 110 generated at the input side of the seed meter 100 by the vacuum producing device 102 loads the seed into one of the holes of the seed disk 104. An actuator rotates the seed disk 104, and the vacuum pressure 110 prevents the seed from dislodging from the hole of the seed disk 104. The seed disk 104 rotates such that when the seed lodged in the hole of the seed disk 104 reaches a certain location within the seed meter 100, the seed experiences a pulling force from the outlet pressure 112. The pulling force dislodges the seed from the hole of the seed disk 104, and as the seed travels a distance, the pulling force becomes a pushing force such that the outlet pressure 112 pushes the dislodged seed towards the soil.

The passive valve 108 can be used to relate the vacuum pressure 110 generated by the vacuum producing device 102 to the outlet pressure 112. FIG. 1 shows that the outlet pressure 112 is generated by the vacuum producing device 102 as well. In some implementations, the generation of the vacuum pressure 110 and the outlet pressure 112 can be accomplished by two different devices and not just the vacuum producing device 102. The passive valve 108 relates the vacuum pressure 110 to the outlet pressure 112 such that the higher the vacuum pressure 110, the higher the outlet pressure 112. The vacuum pressure 110 is a negative air pressure, and the outlet pressure 112 is a positive air pressure. Thus, the passive valve 108 can be controlled such that as the vacuum pressure 110 increases, the outlet pressure 112 increases. In some implementations, the passive valve 108 is a passive differential valve. FIG. 1 is merely provided as an example. In some implementations, instead of adjusting a valve, the vacuum producing device 102 is adjusted based on the level of the vacuum pressure 110 to maintain a relationship between the vacuum pressure 110 and the outlet pressure 112. Adjusting the vacuum producing device 102 can involve reducing a speed of an impeller of the vacuum producing device 102 to reduce the vacuum pressure 110 and the outlet pressure 112.

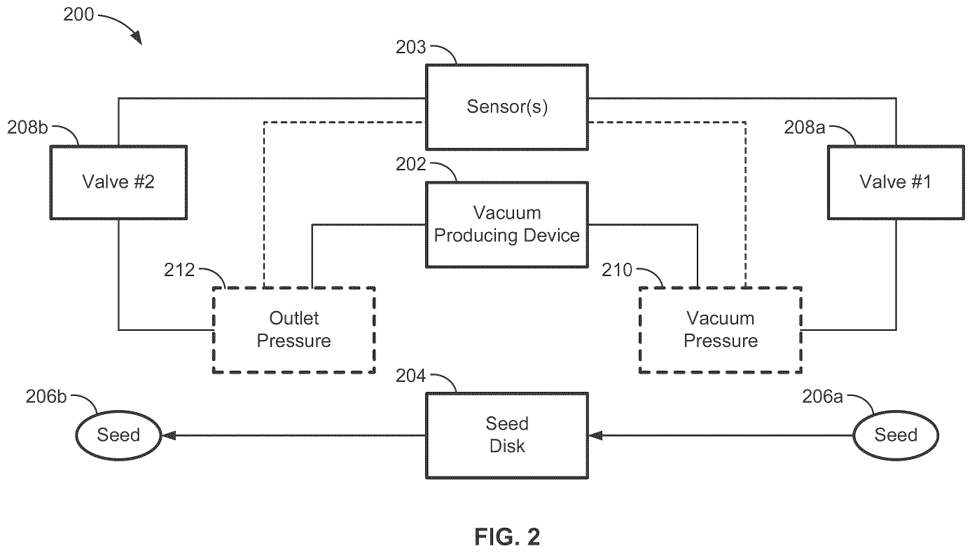

FIG. 2 illustrates a block diagram of a second seed meter 200, according to some implementations of the present disclosure. The seed meter 200 includes a vacuum producing device 202, a seed disk 204, an input side valve 208a, an output side valve 208b, and one or more sensors 203. The seed meter 200 receives a seed at an input side and expels the seed from an output side. In FIG. 2, seed 206a represents the received seed at the input side, and seed 206 represents the expelled seed from the output side. The vacuum producing device 202 generates a vacuum pressure 210 at the input side of the seed meter 200.

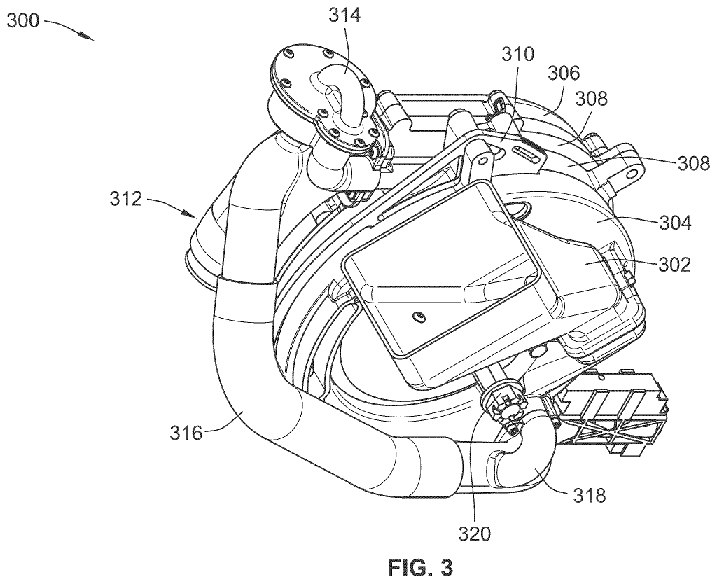

The outlet pressure 212 and the vacuum pressure 210 are similar to or the same as the outlet pressure 112 (FIG. 1) and the vacuum pressure 110 (FIG. 1), respectfully. FIG. 2 provides an alternative to controlling the outlet pressure 212 and the vacuum pressure 210 when compared to the seed meter 100 of FIG. 1. The sensors 203 can include pressure sensors or vacuum sensors for determining at least one of the vacuum pressure 210 and/or the outlet pressure 212. Based on the pressure level of the vacuum pressure 210 recorded by the sensors 203, the valve 208b can be adjusted to modify a level of the outlet pressure 212. Similarly, based on the pressure level of the vacuum pressure 210 recorded by the sensors 203, the valve 208a can be adjusted to modify a level of the vacuum pressure 210. As such, the valves 208a and 208b can be adjusted independently, based on the sensed vacuum pressure 210 and/or the sensed output pressure 212. FIG. 3 provides an example of passive adjustment, according to FIG. 1.

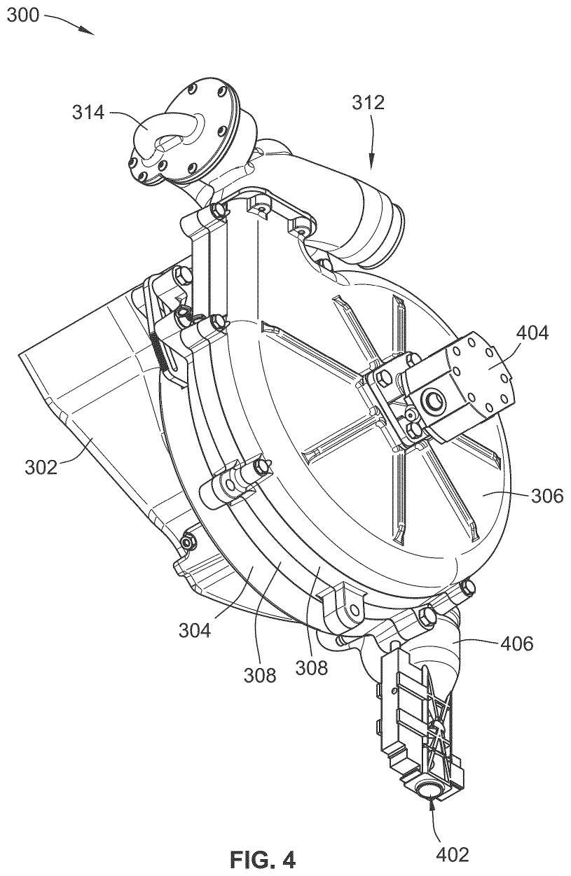

FIG. 3 illustrates a top perspective view of a seed meter 300, according to some implementations of the present disclosure. FIG. 4 illustrates a bottom perspective view of the seed meter 300 of FIG. 3. The seed meter 300 includes a housing with multiple portions including a seed disk housing portion 304, a compressor housing portion 306, and a mating portion 308. The mating portion 308 matches the compressor housing portion 306 and the seed disk housing portion 304. The seed meter 300 includes a seed hopper 302 coupled to the seed disk housing portion 304. The seed meter 300 includes a singulator 310 that interfaces with a seed disk (not shown), situated between the mating portion 308 and the seed disk housing portion 304.

The seed meter 300 includes an air circuit. The air circuit includes a valve 312 and multiple conduit portions 314, 316, 318. The valve 312 can be a westgate device. The valve 312 can include a valve rod with a piston that changes position in response to a level of vacuum pressure within the air circuit. The conduit portion 314 connects the valve 312 to the vacuum created within the within the compressor housing portion 306. Via the conduit portion 314, the position of the piston can respond to the level of vacuum pressure. The conduit portion 316 allows air to flow toward an outlet 402 (FIG. 4). The air flowing within the conduit portion 316 toward the outlet 402 (FIG. 4) can be partially diverted into the conduit portion 318. The partially diverted air flowing through the conduit portion 318 is used to jostle, agitate, or stir seeds within a bottom portion of the seed hopper 302.

In some implementations, the seed meter 300 includes a motor 404 (FIG. 4) used to drive an impeller (not shown) within the compressor housing portion 306. The impeller can be hydraulically powered. Rotating the impeller can create the vacuum within the compressor housing portion 306. The vacuum pressure is communicated to the seed disk housing portion 304. The vacuum pressure facilitates loading seed onto the seed disk provided within the seed disk housing portion 304. The vacuum pressure generated is negative air pressure that sucks seed onto the seed disk and prevents the seed on the seed disk from prematurely dislodging.

Rotating the impeller can generate positive air pressure flowing through the conduit 316 at the same time negative air pressure is being generated within the seed disk housing portion 304. The positive air pressure facilitates dislodging seed from the seed disk (not shown). The positive air pressure also guides the seed, after being dislodged, towards the outlet 402 (FIG. 4). Rotating the impeller can be used to create a high level of vacuum for loading seed onto the seed disk and a positive air pressure for guiding or shooting seed out of the outlet 402 (FIG. 4) and into the soil. A venturi device 406 (FIG. 4) is provided for modulating the positive air pressure of the conduit 316 to create a suction force that sucks seed off the seed disk so that the positive air pressure can guide the seed out of the outlet 402 (FIG. 4). In some implementations, a seed sensor (not shown) attaches or is coupled to the outlet 402 (FIG. 4).

The valve 312 can be used to control the positive air pressure generated for guiding the seed out of the outlet 402 (FIG. 4). When starting the impeller with no seeds on the seed disk, the vacuum pressure is low (i.e., not much vacuum is produced), and the valve 312 is mostly in an open position. The more positive air pressure created to guide seed out of the outlet 402 (FIG. 4), the less vacuum is produced within the seed disk housing portion 304. Initially, very little vacuum is generated when the seed meter 300 is first turned on. The valve 312 being mostly in the open position will not restrict outward flow of the impeller so that the vacuum pressure can be increased within the seed disk housing portion 304. As seed is loaded in the seed disk such that more holes within the seed disk are covered, the vacuum pressure within the seed disk housing portion 304 increases. This increase forces the valve 312 to move toward a closed position. As the valve 312 moves toward the closed position, the positive air pressure generated within the conduit 316 increases. Thus, a passive valve can be used to control both the negative pressure being generated for loading seed onto the seed disk and the positive pressure being generated for guiding seed out of the outlet 402 (FIG. 4).

Although a passive control is described, in some implementations, a vacuum sensor is included in the seed meter 300. The vacuum sensor can sense the vacuum pressure in the seed disk housing portion 304. The sensed vacuum pressure can be used to control an active westgate device. The seed meter 300 includes a seed disk driver 320 for rotating the seed disk. The seed disk driver 320 can be controlled using a gear system (not shown). In some implementations, the seed sensor can be used to determine singulation of seed expelled from the outlet 402 (FIG. 4). Based on the singulation, the outlet pressure (or positive pressure) can be increased or decreased. In some implementations, the vacuum pressure can be increased or decreased based on the singulation.

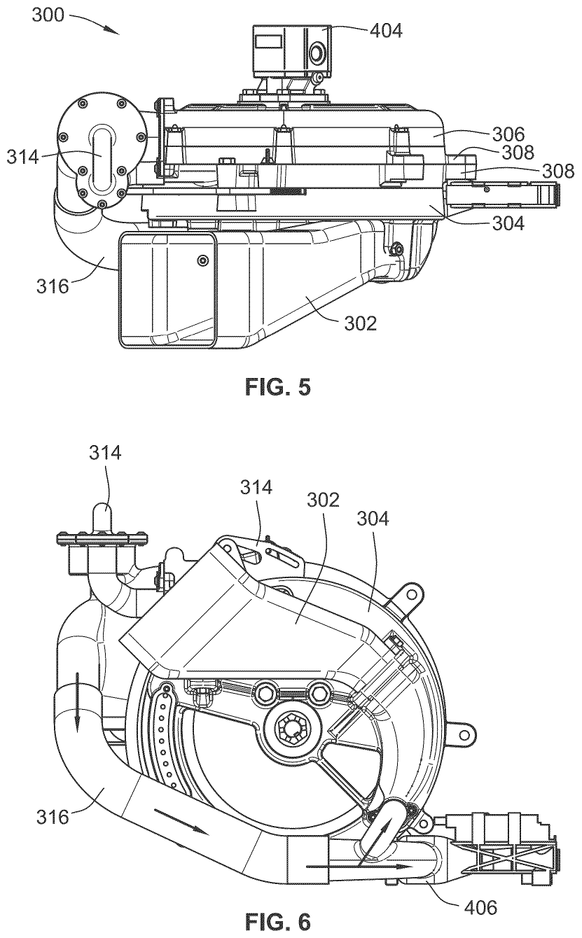

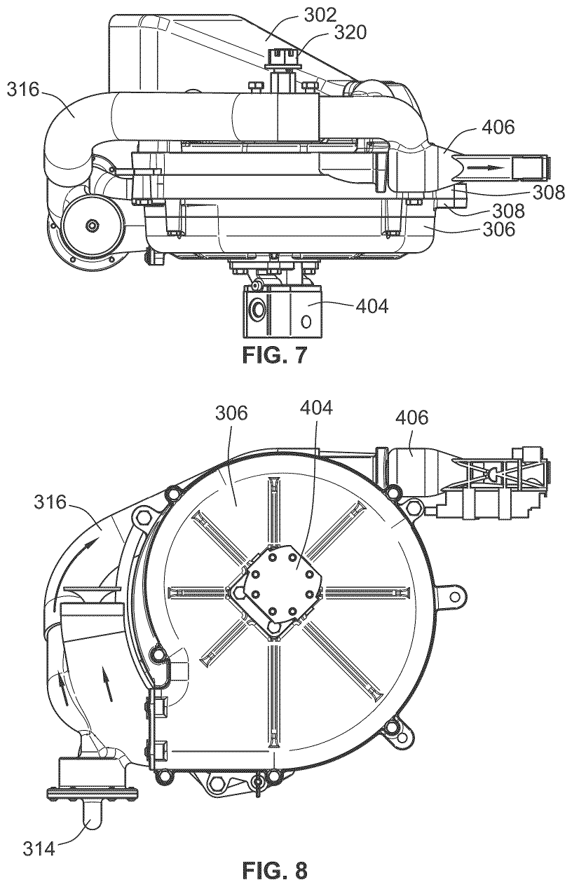

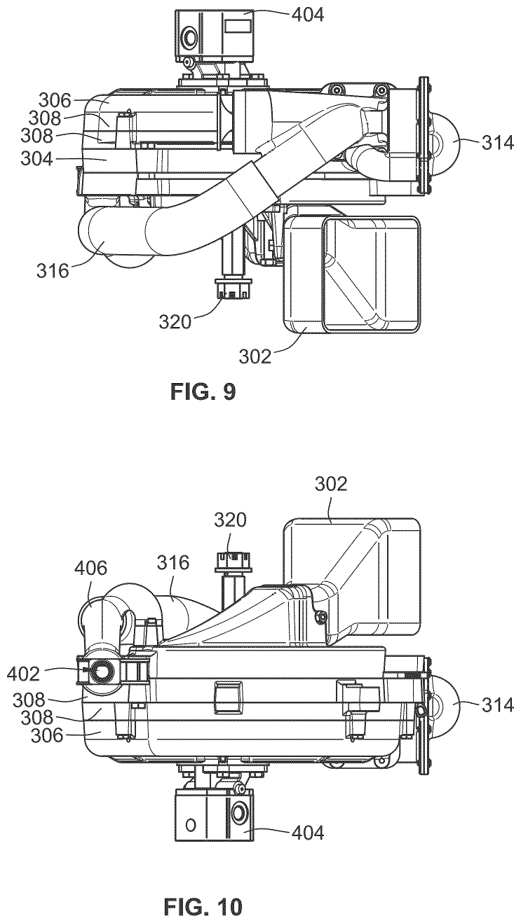

Other views of the seed meter 300 are provided in FIGS. 5 to 10. FIG. 5 illustrates a front plan view of the seed meter 300, FIG. 6 illustrates a right side view of the seed meter 300, FIG. 7 illustrates a back plan view of the seed meter 300, FIG. 8 illustrates a left side view of the seed meter 300, FIG. 9 illustrates a top plan view of the seed meter 300, FIG. 10 illustrates a bottom plan view of the seed meter 300.

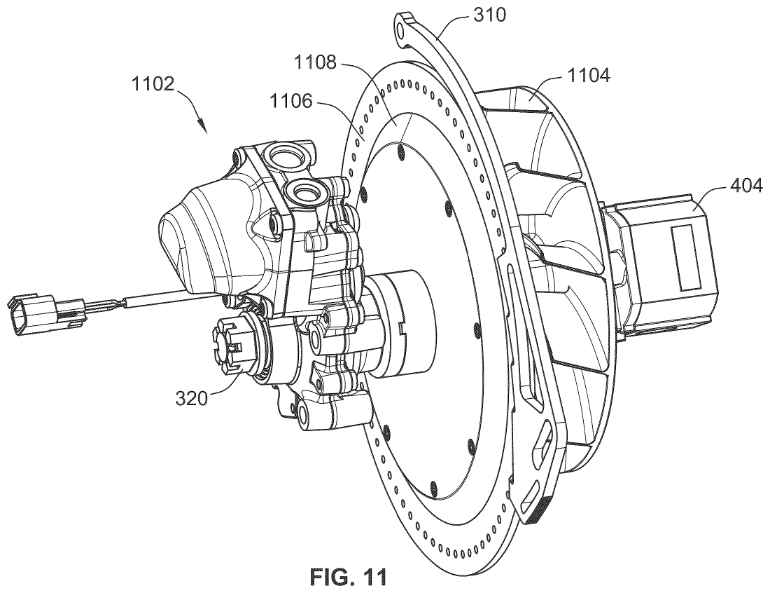

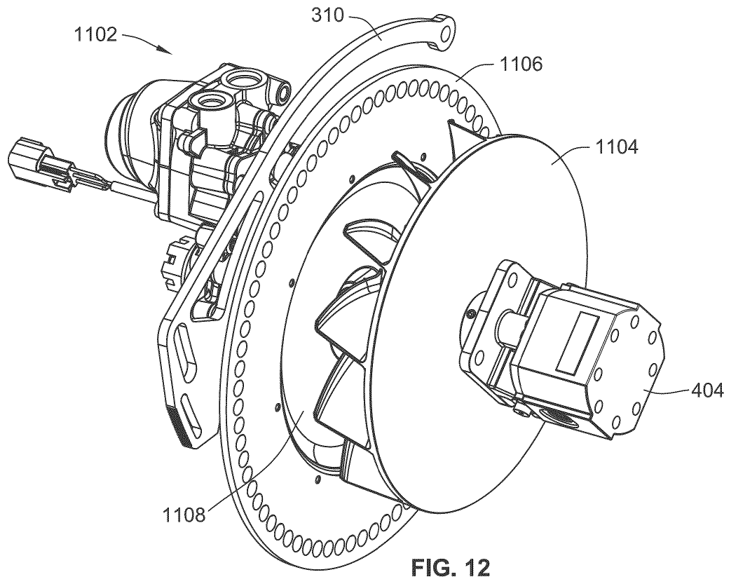

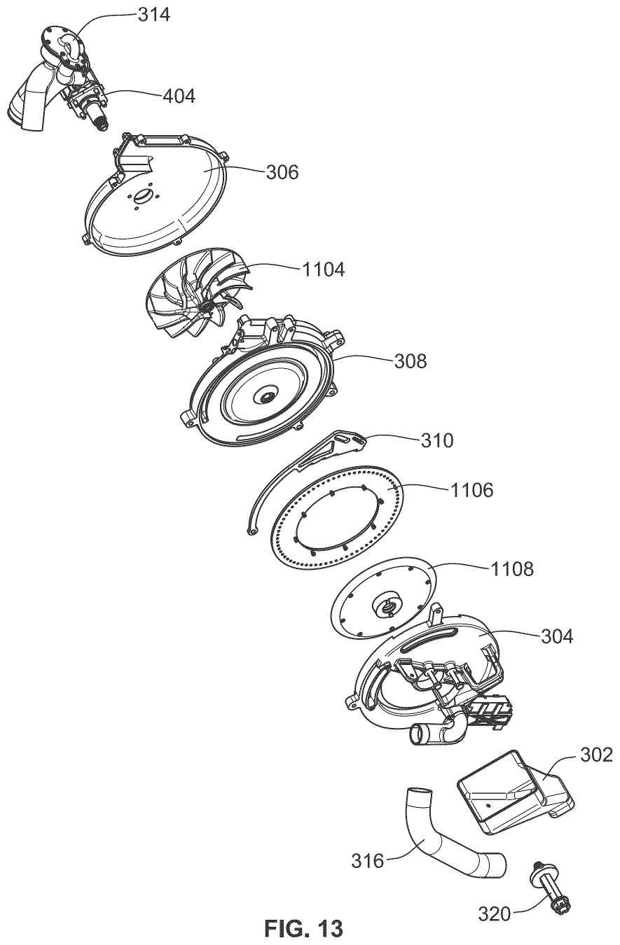

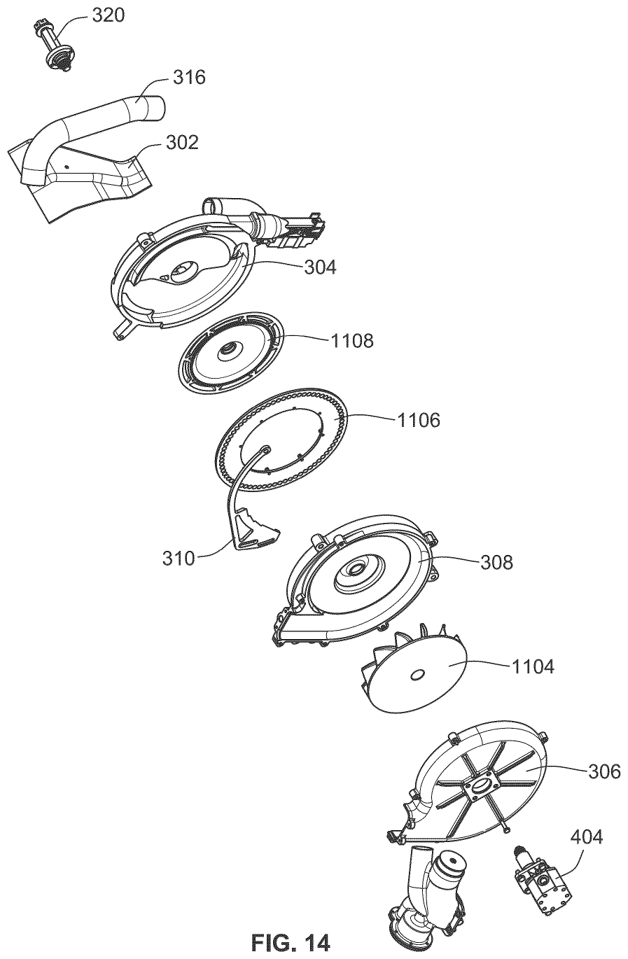

FIG. 11 illustrates a left perspective view of components of the seed meter 300 without housing portions (e.g., the seed disk housing portion 304, the compressor housing portion 306, and the mating portion 308), according to some implementations of the present disclosure. FIG. 11 provides an example of an impeller 1104 driven by the motor 404 to generate vacuum and a gear system 1102 for controlling the seed disk driver 320. The seed disk driver 320 is coupled to a seed plate 1108 attached to a seed disk 1106. The seed disk 1106 can include 72 holes. The seed disk 1106 can be used to plant soybeans or corn as such, there is no need to switch between seed disks for different crops. The rotation speed of the seed disk 1106 can be changed to achieve appropriate seed separation for the different crops. FIG. 12 illustrates a right perspective view of the component arrangement of FIG. 11. FIGS. 13 and 14 illustrate exploded views of the seed meter 300, according to some implementations of the present disclosure.

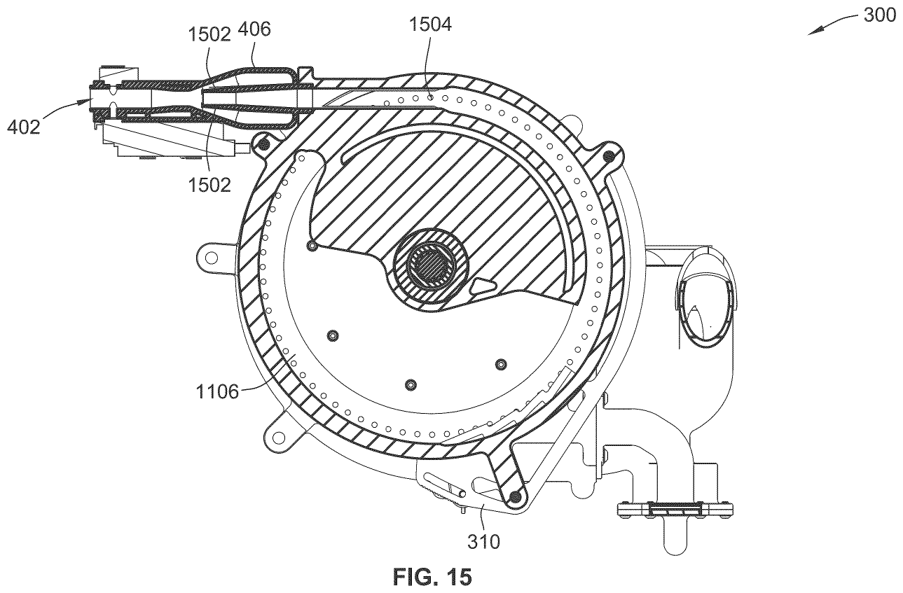

FIG. 15 illustrates a cross section of the seed meter 300, according to some implementations of the present disclosure. The venturi device 406 can include an inner diameter formed by walls 1502. The walls 1502 are tapered to reduce the inner diameter when moving from the seed disk 1106 toward the outlet 402. Referring to FIG. 6, the conduit 316 provides positive air pressure to the venturi device 406. Referring back to FIG. 15, the walls 1502 when encountering the positive air pressure, creates a suction to dislodge a seed at, for example, location 1504.

Seed meters according to some implementations of the present disclosure can be mounted on an agricultural planter. The agricultural planter can include rows of seed meters. At least one of the seed meters can be mounted such that an axis of a respective outlet is positioned between 0 degrees to 90 degrees relative to the surface of the farmland on which the agricultural planter sits. The seed meter can be mounted such that the axis of the outlet of the seed meter is at a 45-degree angle. In some implementations, one or more valves as discussed herein (e.g., the valves 208a, 208b, 312, etc.) can be actively controlled based on a forward operating speed of the agricultural planter.

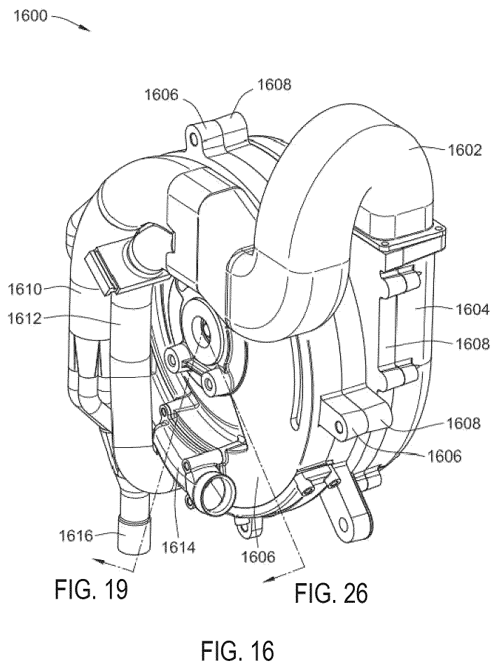

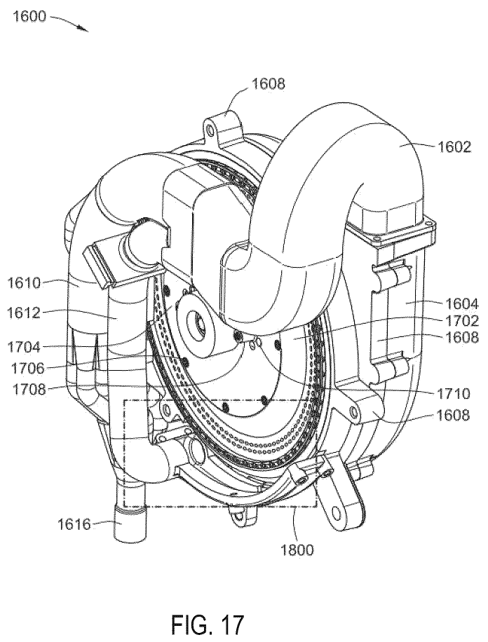

FIGS. 16 and 17 illustrate top perspective views of a seed meter 1600, according to some implementations of the present disclosure. FIG. 17 shows the seed meter 1600 of FIG. 16 with certain components removed (e.g., seed disk housing portion 1606, seed tube 1614, etc., discussed further below) in order to reveal a seed disk within an interior of the seed meter 1600. The seed meter 1600 includes a housing with multiple portions including a seed disk housing portion 1606, a compressor housing portion 1604, and a mating portion 1608. The seed meter 1600 can also include a seed tube 1614 that can couple to a seed hopper (not shown) for introducing seeds to the seed meter 1600. As further discussed below, the seed tube 1614 can include a semi-circular (e.g., hemispherical), rectangular, elliptical or any other suitable shape for providing a passage way from the seed hopper (not shown) to an interior of the seed meter 1600.

In some implementations, the seed meter 1600 may not include a mechanical singulator. Instead, the seed meter 1600 can utilize positive airflow to achieve functions associated with a singulator while also improving on the accuracy, speed and other limitations associated with mechanical singulators. Indeed, as noted above, certain mechanical singulator designs can damage seeds, become a limitation on an upper limit of angular speed of a spinning seed disk, and exhibit other deficiencies and inefficiencies.

In some implementations, seed singulation through positive airflow can be achieved, at least in part, by incorporating a specially-designed air circuit into a seed meter. FIGS. 16 and 17 include such an air circuit. Indeed, as shown in FIGS. 16 and 17, the seed meter 1600 includes an exemplary air circuit that includes multiple conduit portions 1602, 1610, 1612, 1616. Collectively, these conduit portions 1602, 1610, 1612, 1616 cooperate to direct positive airflow generated from within the seed meter 1600 to other interior portions of the seed meter 1600 to facilitate singulator functions. For example, the conduit portion 1602 may be configured to guide positive airflow from the housing portion 1604 through other conduit portions 1610, 1612, 1616. As discussed above, an impeller (not shown) rotating within the compressor housing portion 1604 can create the positive airflow that flows through the conduit portion 1602 at the same time negative air pressure is being generated within the compressor housing portion 1604. Some of the airflow flowing through the conduit portion 1602 can then be redirected to the conduit portion 1610 to run a venturi device (not shown), and some of the airflow flowing through the conduit portion 1602 can be redirected to the seed disk housing portion 1606 to agitate seeds and provide a singulator function.

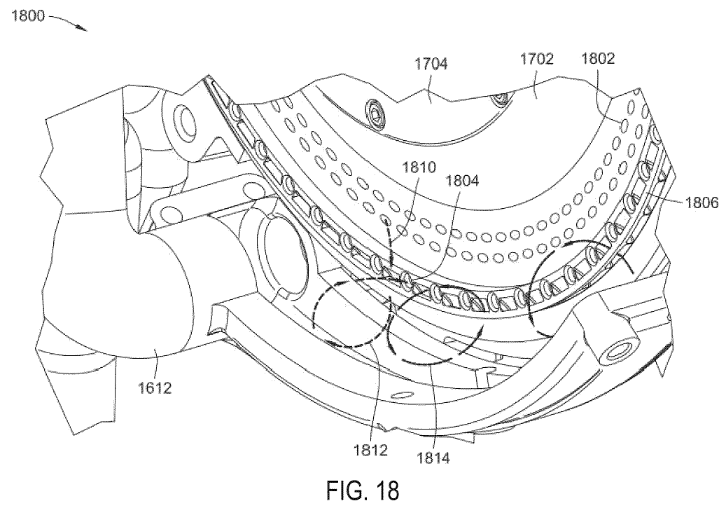

Referring to FIG. 17, the seed disk within the interior of the seed meter 1600 is shown and can include an inner disk portion 1704 and an outer disk portion 1702. The inner disk portion 1704 of the seed disk can be configured to facilitate a mounting of the seed disk to an axle connected to a motor (not shown). The outer disk portion 1702 of the seed disk can include areas for capturing seeds for planting, for creating an air wall that prevents seed accumulating on the seed disk, and for creating directional airflow to facilitate seed agitation and placement for dispensing, as further discussed below with reference to FIG. 18.

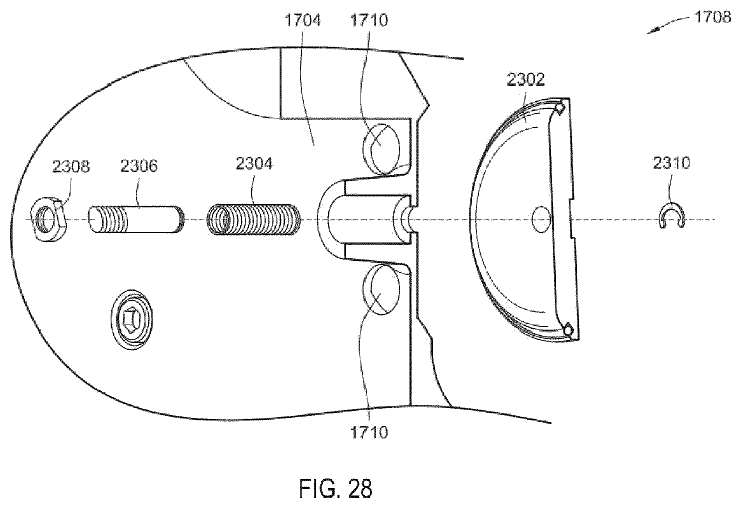

The inner disk portion 1704 can be attached to the outer disk portion 1704 using any suitable quantity and type of fasteners 1706 (e.g., screws). The inner disk portion 1704 can also include one or more spring assemblies 1708 configured to implements a valve for opening one or more holes 1710 within the inner disk portion 1704. The spring assemblies 1708 are used as examples, but in some implementations, the amount of opening of the one or more holes 1710 can be set manually, as opposed to being determined using a spring assembly. The spring assemblies 1708 are further described below in connection with FIG. 28.

Turning now to FIG. 18, illustrates a zoomed in view of a portion 1800 of the seed meter 1600 shown in FIG. 17, which reveals certain interior components of the seed meter 1600. FIG. 18 also illustrates the positive and/or directional airflow 1810, 1812, 1814 generated within the zoomed in portion 1800 through the seed disk of FIG. 17, according to some implementations of the present disclosure.

As shown in FIG. 18, the seed disk further includes air bearings 1802, holes 1804, and a railing 1806 on the outer disk portion 1702. It should be noted, however, that other implementations can include seed disks having more or fewer air bearings, holes and/or railing openings, and the air bearings, holes and/or railing openings may be spaced, sized, shaped and/or arranged according to each such other implementation.

The air bearings 1802, in this illustrative example, can be configured (e.g., sized, shaped, angled, etc.) to emit streams of positive airflow 1810 (e.g., from within the compressor housing portion 1604 through each air bearing 1802) in a generally outwardly and downwardly direction, thereby creating virtual air barrier (or airwall) in front of the air bearings 1802 and other portions of the outer disk portion 1702. This airwall, in turn, prevents seeds from accumulating on the seed disk by reducing or counter-acting the friction between the seeds and a surface of the seed disk. As a result, the seed disk (e.g., as shown in FIG. 17) is able to operate at speeds much faster than those of conventional seed meters, including upwards of 100 rotations per minute or more.

In addition, the positive airflow 1810 emitted from the air bearings 1802 can interact with airflow emitted from the conduit portion 1612. As noted above, airflow emitted from the conduit portion 1612 can originate as negative airflow in the compressor housing portion 1604 (FIG. 17) that has been redirected and guided through one or more other conduit portions 1602. As a result of the interaction of airflows from the air bearings 1802 and the conduit portion 1612, a circulating airflow 1812 can be formed. The circulating airflow 1812 can rotate in a clockwise or counterclockwise direction, including in a spiraling clockwise direction, according to the particular implementation. In this example, the direction of the circulating airflow 1812 is indicated by the arrows shown in FIG. 18. The circulating airflow 1812 can jostle, agitate, and/or stir seeds within the seed meter and facilitate singulator functions, as further discussed below.

Notably, the (positive) circulating airflow 1812 can also create a negative airflow through other openings in the seed disk, such as through the holes 1804 of the seed disk. This negative airflow can bolster any existing negative airflow that is already passing through the holes 1804, such as the negative airflow resulting from the vacuum generated within the compressor housing portion 1604. Collectively, the negative airflow flowing through the holes 1804 can operate to guide, position and hold seeds in the holes 1804 until the seeds are ready to be discharged for planting.

The positive airflow 1810 emanating from the air bearings 1802 can also interact with the positive airflow from the conduit portion 1612, and as a result, generate a further circulating airflow 1814 that allows air to pass through openings provided between the railing 1806 and the surface of the outer disk portion 1702. Thus, while the circulating airflow 1812 discussed above facilitates mounting seeds to the holes 1804, the circulating airflow 1814 passing through the openings provided between the railing 1806 facilitates the removal of seeds stuck within the openings due to the railing 1806, for example. In this manner, the positive airflow 1810 emanating from the air bearings 1802, the positive airflow emanating from the conduit portion 1612, the resulting circulating airflows 1812, 1814 and the negative airflow negative flowing through the holes 1804 of the seed disk collectively cooperate to facilitate in performing singulator functions.

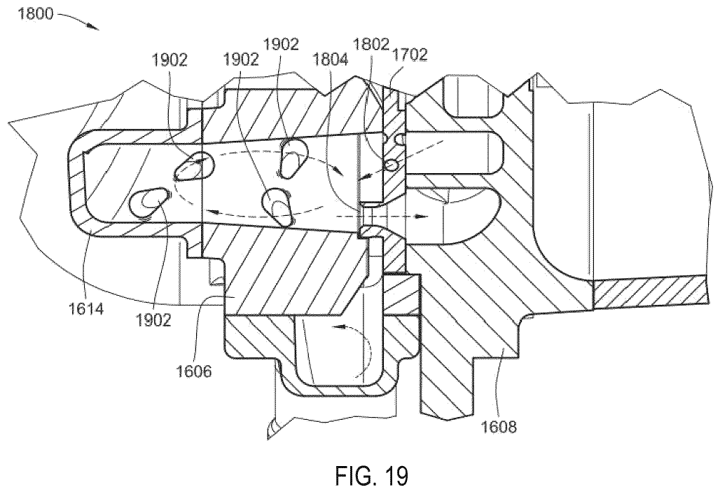

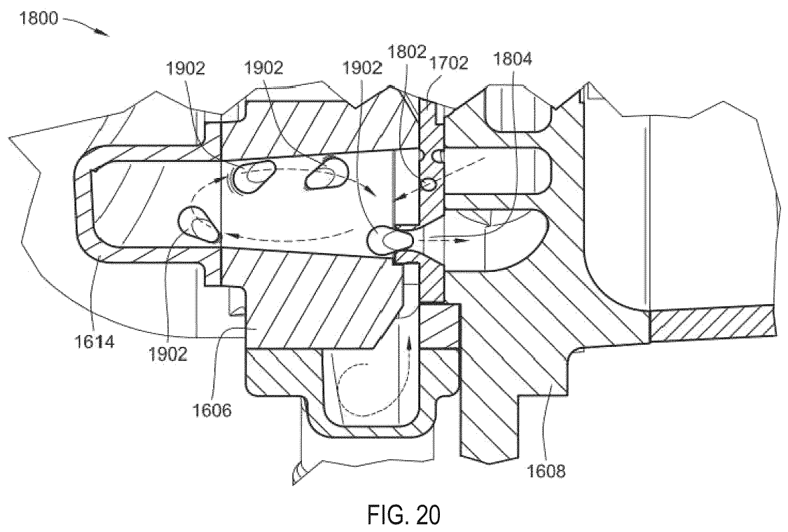

Turning now to FIG. 19, a further zoomed in and cross-sectional view of a second portion 1800 of the seed meter 1600 of FIG. 17 is shown. In this view, visible components of the seed meter 1600 include the seed disk housing portion 1606, the mating portion 1608, the seed tube 1614, the outer disk portion 1702, the air bearings 1802, and the holes 1804 in the seed disk. Also shown in this FIG. 19 are a plurality of seeds 1902 that have been introduced into the seed meter 1600 via the seed tube 1614, where the seeds 1902 are jostling around within an interior of the seed disk housing portion 1606 proximate to the outer disk portion 1702 of the seed disk. The jostling of the seeds 1902 can be driven by the streams of positive airflow 1810 emitted from air bearings 1802 and the airflow that is emitted from the conduit portion 1612 (not shown, see FIG. 18). As discussed above, the interaction between the airflows from the air bearings 1802 and the conduit portion 1612 (not shown) can create a circulating airflow 1812. The rotational force of the circulating airflow 1812 can rotate jostle the seeds 1902 within an interior of the seed disk housing portion 1606 until each seed 1902 is mounted in a corresponding hole 1804, as shown in FIG. 20.

Indeed, FIG. 20 illustrates the further zoomed in and cross-sectional portion 1800 shown in FIG. 19, but with one of the seeds 1902 being mounted on the seed disk of the seed meter 1600, according to some implementations of the present disclosure. As previously explained, the circulating airflow 1812 causing the seeds 1902 to jostle can also create a negative airflow through the holes 1804 of the seed disk. This negative airflow, together with the negative airflow resulting from the vacuum generated within the compressor housing portion 1604 (not shown, see FIG. 17), can operate to mount and hold the seeds 1902 in the holes 1804 of the seed disk until the seeds are ready to be discharged for planting.

In some embodiments, the holes 1804 of the seed disk can be configured with openings that are sized, shaped and/or contoured such that the seeds 1902 can only be mounted if oriented in a certain direction. To illustrate, the holes 1804 can have funnel-shaped openings, so as to accommodate corn, soybeans and/or other irregular shaped seeds in a particular orientation.

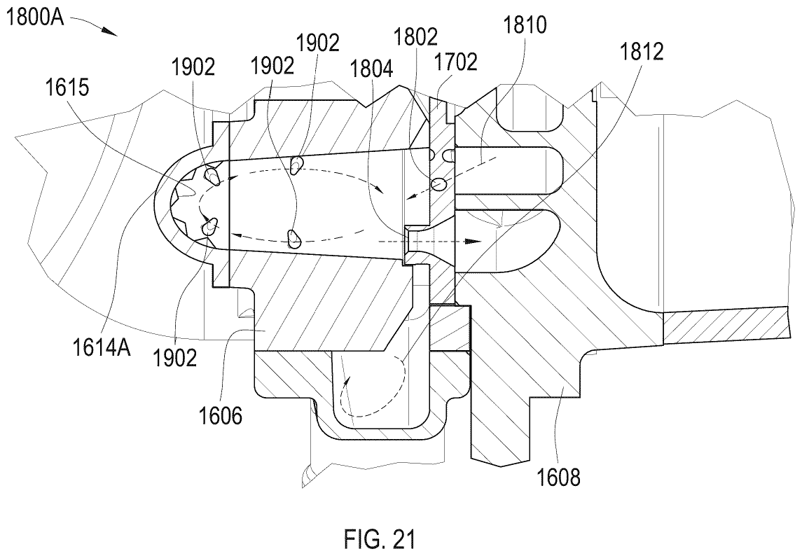

Turning now to FIG. 21, a zoomed in and cross-sectional view of a portion 1800A of an alternate embodiment of the seed meter 1600 of FIG. 17 is shown. At least a portion of the seed tube 1614A shown in this FIG. 21 can be rounded or elliptical in shape (e.g., a semi-cylinder), and can include an interior surface having a continuous or semi-continuous groove 1615 formed therein that extends from a first end of the seed tube portion 1614A to a second end of the seed tube portion 1614A. As further discussed below, the spiral groove 1615 on the interior surface seed tube portion 1614A is operable to guide seeds along its groove path in an orderly manner and in a direction that is opposite that of the rotation of the seed disk and circulating air pressure resulting therefrom. In this manner, the grooved seed tube portion 1614A, together with air pressure, are able to counteract the effects and problems of seed propagation.

Indeed, as seeds 1902 are funneled through the seed tube portion 1614A and into the seed meter (e.g., to an interior of the seed disk housing portion 1606 proximate to the outer disk portion 1702 of the seed disk), the seeds 1902 tend to form a pool of seeds proximate to the outer disk portion 1702 of the seed disk. As discussed above, the circulating airflow 1812 operates to jostle the seeds 1902 as part of a singulator function. However, as the rotation speed of seed disk increases, the force of the circulating airflow 1812 and/or other positive air pressures similarly increase, resulting in propagation of the seeds 1902. That is, the faster the seed disk rotates, the resulting air pressure (including circulating airflow 1812) and force (e.g., friction from the seed disk) acting upon the seeds 1902 similarly increases, forcing the seeds 1902 away from the seed disk and back towards the seed tube portion 1614A. As this occurs, the air pressure driving the seeds 1902 towards the seed tube portion 1614A also forces the seeds 1902 against an angled surface of the spiral groove 1615 and guides the seeds 1902 along the spiral groove's path. Because the spiral groove 1615 is oriented in a direction that is opposite that of the circulating airflow 1812, the seeds 1902 are guided in a direction that is opposed to the direction in which the seeds 1902 are being propagated. Thus, if the circulating airflow 1812 and seed disk rotate in a clockwise direction, the path of the spiral groove 1615 would direct the seeds 1902 in a counterclockwise direction, and vice versa. In this manner, the combination of air pressure and a grooved interior of the seed tube 1614A operate to counteract the propagation of the seeds 1902 in the seed meter.

In some embodiments, the spiral groove 1615 can include a predetermined pitch, depth and groove angle, and be shaped to accommodate and guide the seeds 1902 along the groove path. In some embodiments, edges of the spiral groove 1615 can be triangular, so as to reduce a surface area of the spiral groove 1615 on which dust may collect and accumulate (e.g., from the seeds 1902 moving therethrough).

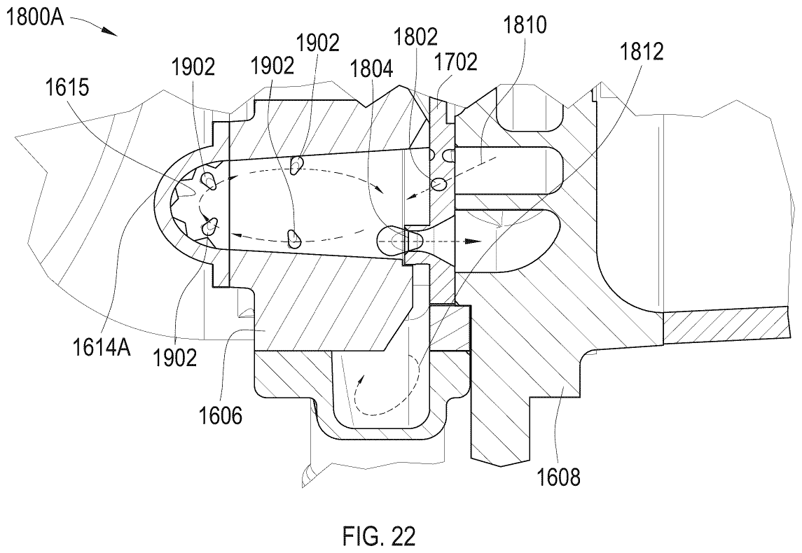

FIG. 22 illustrates a seed being captured on a seed disk of the alternate embodiment of the seed meter of FIG. 21. As discussed above, positive air pressure and the grooved interior surface of the seed tube portion 1614A operate to counteract seed propagation, thereby facilitating the mounting of the seed 1902 into the hole 1804.

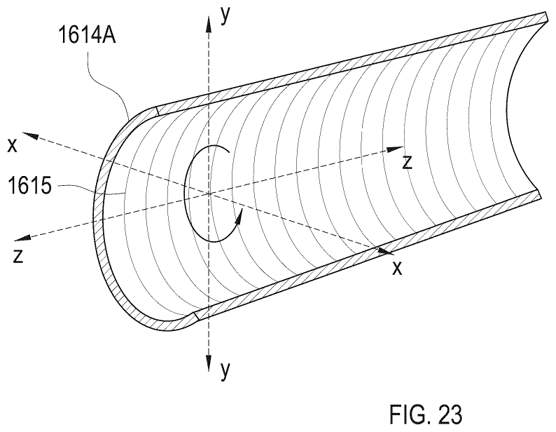

FIG. 23 illustrates a left perspective view of seed tube portion 1614A of the seed meter of FIGS. 20 and 21. As shown, the seed tube portion 1614A includes an interior surface having a continuous spiral groove 1615 therein. In some embodiments, however, the spiral groove 1615 can include a semi-continuous or non-continuous spiral groove. In some embodiments, portions of the spiral groove may be continuous, while other portions may be semi-continuous or non-continuous.

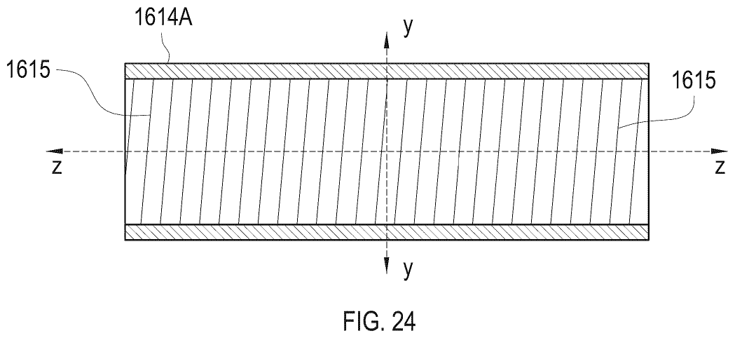

FIG. 24 illustrates a cross-sectional view of the seed tube portion 1614A of FIG. 23. As in FIG. 24, the seed tube portion 1614A includes an interior surface having a continuous spiral groove 1615 therein. Alternatively, the spiral groove 1615 can include a semi- or non-continuous spiral groove.

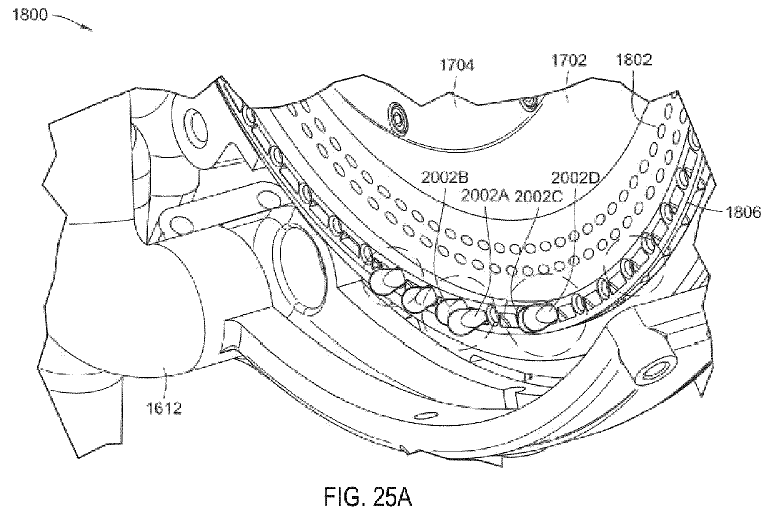

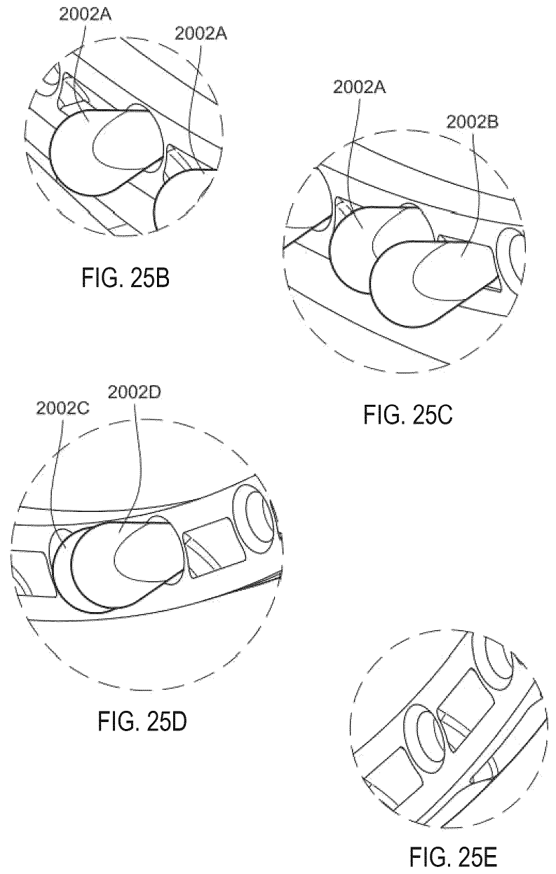

FIG. 25A illustrates several examples of seeds 2002A, 2002B, 2002C, and 2002D being captured on the seed disk of the seed meter 1600. FIG. 25B illustrates a zoomed in portion of FIG. 25A showing a single seed capture, according to some implementations of the present disclosure. This is the desired seed capture. FIG. 25C illustrates a zoomed in portion of FIG. 25A showing a first example of an improper seed capture, according to some implementations of the present disclosure. The seed 2002B is improperly captured at the opening formed by the railing 1806 as discussed above. FIG. 25D illustrates a zoomed in portion of FIG. 25A showing a second example of an improper seed capture, according to some implementations of the present disclosure. Two seeds 2002C and 2002D are stuck to the same hole 1804. This is a double capture. FIG. 25E illustrates a zoomed in portion of FIG. 25A showing a third example of an improper seed capture (a skip), according to some implementations of the present disclosure. That is, no seed is captured in the hole 1804.

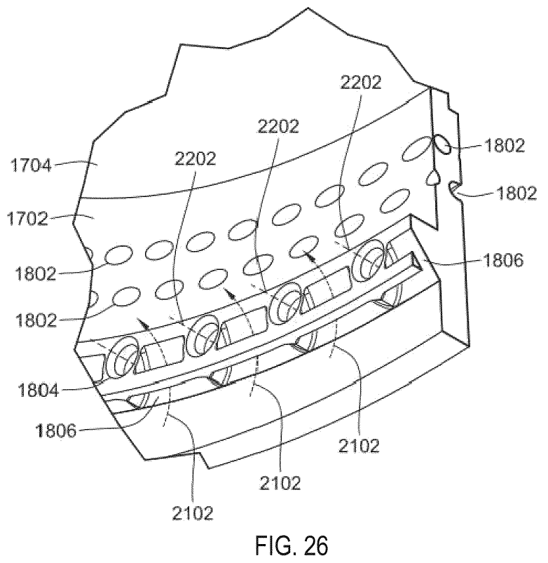

FIG. 26 illustrates a portion of the seed disk of FIG. 17, showing airflow at the edge of the seed disk, according to some implementations of the present disclosure. The airflow 2102 shows a positive airflow through openings in the railing 1806 for dislodging the seed 2002B (FIG. 25C). The airflow 2102 can also help dislodge one of the doubly captured seeds shown in FIG. 25D. The airflow 2202 shows a negative airflow through the holes 1804 for seating or capturing a seed to the hole 1804s (e.g., the seed 2002A of FIG. 25B).

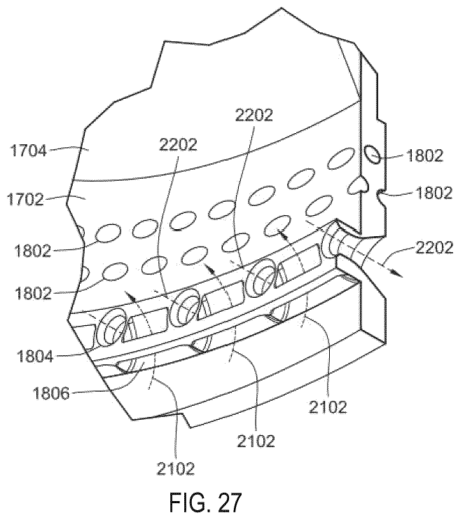

FIG. 27 illustrates another portion of the seed disk of FIG. 17, showing airflow at an end of the seed disk, according to some implementations of the present disclosure. FIG. 27 also shows that the hole 1804 have a funnel shape. In some embodiments, the holes 1804 can sized, shaped, angled or otherwise configured according to the particular implementation (e.g., according to the size and type of seed being metered).

FIG. 28 illustrates a valve system on the seed disk of FIG. 17, according to some implementations of the present disclosure. The valve system includes the spring assembly 1708 which includes a spring 2304, a stopper 2302, a rod 2306, a washer 2308, and a horseshoe washer 2310. The valve system is a passive relief valve to modulate vacuum pressure and allow air to bypass when the stopper 2302 uncovers the holes 1710. The spring 2304 is calibrated to maintain an optimum vacuum in the compressor housing portion 1604. In some implementations, the vacuum generated in the seed meter 1600 is around 15-20 inches of water (inH₂O). The spring constant of the spring 2304 is designed to modulate the vacuum pressure around 15-20 inH₂O. The diameter of the holes 1710 or the number of the holes 1710 are also factors considered to maintaining the vacuum pressure.

One or more elements or aspects or steps, or any portion(s) thereof, from one or more of any of claims 1-3 below can be combined with one or more elements or aspects or steps, or any portion(s) thereof, from one or more of any of the other claims 1-3 or combinations thereof, to form one or more additional implementations and/or claims of the present disclosure.

While the present disclosure has been described with reference to one or more particular embodiments or implementations, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations according to aspects of the present disclosure may combine any number of features from any of the implementations described herein.

What is claimed is:

1. A seed meter, comprising:
a seed disk provided in a seed disk housing, the seed disk comprising a plurality of air bearings and a plurality of holes for receiving seeds; and
a vacuum producing device generating a vacuum pressure in the seed disk housing,
the vacuum pressure generating a first negative airflow through the plurality of holes for loading and holding each of the plurality of seeds into a respective hole from among the plurality of holes, and
the plurality of air bearings emitting a first positive airflow for repelling one or more seeds from among the plurality of seeds from other parts of the seed disk.

2. The seed meter of claim 1, wherein each of the plurality of air bearings is angled such that the first positive air flow is emitted in a corresponding angled and downwardly direction.

3. The seed meter of claim 1, wherein the plurality of holes comprises hole openings having a funnel shape for receiving and holding the plurality of seeds in a predetermined orientation.

4. The seed meter of claim 1, further comprising an air circuit that includes one or more conduit portions, the air circuit configured to direct and emit a second positive airflow into the seed disk housing,
wherein the second positive airflow interacts with the first positive airflow to form a first circulating airflow that jostles at least a portion of the plurality of seeds within the seed meter.

5. The seed meter of claim 4, wherein the first positive airflow and the second positive airflow are generated by the vacuum producing device and redirected to the plurality of air bearings and the air circuit, respectively, for emitting the same.

6. The seed meter of claim 4, wherein the first circulating airflow creates a second negative airflow through at least one hole from among the plurality of holes, the second negative airflow interacting with the first negative airflow to increase an overall negative airflow through the at least one hole for mounting and holding a respective seed therein.

7. The seed meter of claim 4, wherein the seed disk further comprises a railing that includes a plurality of railing openings, each of said plurality railing openings positioned proximate to a respective hole from among the plurality of holes on the seed disk,
wherein the second positive airflow interacts with the first positive airflow to form a second circulating airflow that allows air to pass through the plurality of rail openings to remove seeds that are stuck in components of the seed disk.

8. The seed meter of claim 7, wherein the second circulating airflow removes multiple seeds that are stuck in a same hole.

9. The seed meter of claim 1, further comprising a seed tube coupled to the seed disk housing, the seed tube configured to introduce the plurality of seeds into the seed meter.

10. The seed meter of claim 9, wherein the seed tube comprises a seed tube portion that is at least one of rounded and elliptical in shape, the seed tube portion having an interior surface comprising a spiral groove formed therein, the spiral groove extending from a first end of the seed tube portion to a second end of the seed tube portion.

11. The seed meter of claim 10, wherein the spiral groove comprises one of a continuous spiral groove and a semi-continuous spiral groove.

12. The seed meter of claim 11, wherein positive air presser formed within the seed disk housing drives a portion of the plurality of seeds into the seed tube portion,
the positive air pressure forcing the portion of the plurality of seeds against an angled surface of the spiral groove and in response,
the spiral groove guiding the portion of the plurality of seeds along a groove path of the spiral groove in a direction that is opposite that of a rotation of the seed disk.

13. The seed meter of claim 12, wherein one or more edges of the spiral groove are triangular in shape.

14. The seed meter of claim 1, wherein the vacuum producing device comprises an impeller in a compressor housing, the compressor housing being coupled to the seed disk housing.

15. The seed meter of claim 1, wherein the seed disk is operable to dispense at least one of corn and soybeans.

16. A seed meter, comprising:
a seed disk provided in a seed disk housing, the seed disk configured to load seed in specific holes in presence of a vacuum pressure at the specific holes and repel seed from other parts of the seed disk using positive airflow from air bearings of the seed disk.

17. A seed meter, comprising:
a seed disk with angled air bearings that shoot positive airflow to perform a singulator function.

18. A seed meter, comprising:
a housing; and
a seed disk provided within the housing, the seed disk having a passive relief valve to modulate vacuum pressure within the housing.
